(19) United States
(12) Patent Application Publication
(10) Pub. No.: US 2022/0243395 A1
(43) Pub. Date: Aug. 4, 2022

(54) PROCESS FOR CONTINUOUSLY PREPARING A BROKEN-UP CELLULOSE-CONTAINING STARTING MATERIAL

(71) Applicant: LENZING AKTIENGESELLSCHAFT, Lenzing (AT)

(72) Inventors: Richard HERCHL, Ried im Innkreis (AT); Christian WEILACH, Vöcklabruck (AT)

(21) Appl. No.: 17/596,097

(22) PCT Filed: May 29, 2020
(86) PCT No.: PCT/EP2020/065047

§ 371 Date: Dec. 2, 2021

(30) Foreign Application Priority Data
Jun. 4, 2019 (EP) 19178170.7

(51) Int. Cl. D21C 5/00; D21C 3/02; D21C 9/10; C08J 11/16

(52) U.S. Cl. CPC D21C 5/00; D21C 3/02; C08J 2301/02; C08J 11/16; D21C 9/10

(57) ABSTRACT

A method for continuously providing a treated cellulose-comprising starting material (110), in particular as starting material for manufacturing a cellulosic molded body (102), is provided. The method comprises: i) supplying (10) a cellulose-comprising starting material (101), which in particular is a solid matter, with a predefined composition to a reactor device (105), ii) continuously treating (20) the starting material (101) in the reactor device (105), to obtain the treated cellulose-comprising starting material (110), and iii) discharging (30) the treated cellulose-comprising starting material (110) from the reactor device (105).

### CROSS-REFERENCE TO RELATED APPLICATION(S)

This application is a national US phase of PCT/EP2020/065047 which claims the benefit of the filing date of European Patent Application No. 19178170.7 filed 4 Jun. 2019, the disclosure of which is hereby incorporated herein by reference.

### TECHNICAL FIELD

Embodiments of the invention relate to a method for continuously providing a cellulose-comprising treated starting material from a cellulose-comprising starting material, which has a predefined composition. Moreover, embodiments of the invention relate to a method for manufacturing a, in particular regenerated, cellulosic molded body from the treated starting material. Furthermore, the embodiments of the invention relate to a use of a continuous boiling aggregate for continuously treating a cellulose-comprising starting material, in particular used textiles; with a predefined composition.

Thus, embodiments of the invention may relate to the technical field of providing treated, cellulose-containing starting materials. In particular, embodiments of the invention may relate to the technical field of manufacturing a (regenerated) cellulosic molded body from a treated, cellulose-containing starting material. Furthermore, embodiments of the invention may relate to the technical field of recycling solid matters, in particular used textiles.

### TECHNOLOGICAL BACKGROUND

Providing a cellulose-containing, treated starting material, e.g. for manufacturing a (regenerated) cellulosic molded body, is conventionally performed by a discontinuous manufacturing method. However, a cellulose-comprising starting material, which is a solid matter (German: Feststoff) and which is to be treated, does usually not comprise a homogenous composition. Instead, the substance compositions of used textiles, for example, which may be used as solid starting material, may strongly fluctuate. Thus, a discontinuous treatment process is possible, wherein the starting material is supplied in a batchwise manner. In this way, the process conditions of the composition of each batch may be individually adapted. According to an example, a discontinuously operated boiling aggregate is conventionally used, which is initially filled with the starting material (first batch) and at least one disintegrating agent (German: Aufschlussmittel) or reaction medium. Subsequently, the boiling aggregate is heated, to solve e.g. in the case of wood chips the lignin, and to enable the recovery of the cellulose. The obtained suspension with the recovered cellulose is then discharged and residues are removed from the boiling aggregate. After an additional cleaning stage, the reactor is then filled with a new, second batch and the discontinuous process starts again. In summary, a multiplicity of operating stages are required, which in turn require a multiplicity of instruments of the measuring and control technology. In summary, the control of these processes is challenging, since each batch has other (substance) properties and the respective operating conditions have to be adapted. Moreover, by the multiplicity of the single stages, there is no possibility to provide a large, compact aggregate. Instead, the stages are distributed to many single aggregates. Finally, also the energy consumption is relatively high, since the boiler has to be reheated for each batch, for example.

### SUMMARY OF THE INVENTION

There may be a need to provide a treated cellulose-containing starting material (e.g. for manufacturing a (regenerated) cellulosic molded body) in an efficient, robust, and resource saving manner.

The subject matters according to the independent patent claims are provided. Preferred embodiments result from the dependent claims.

According to an aspect of the present invention, a method for continuously providing a treated cellulose-comprising starting material (wherein in particular the starting material is suitable for manufacturing a (further in particular regenerated) cellulosic molded body) is described. The method comprises: i) supplying a cellulose-comprising starting material, which in particular is a solid matter (further in particular used textiles), with a predefined composition to a reactor device (e.g. a boiling aggregate), ii) continuously treating (in particular recovering cellulose by performing a boiling) the cellulose-comprising starting material in the reactor device, to obtain the treated cellulose-comprising starting material, and iii) discharging the treated cellulose-comprising starting material from the reactor device.

According to a further aspect of the present invention, a method for manufacturing a (in particular regenerated) cellulosic molded body is described. The method comprises: i) providing the above described treated cellulose-comprising starting material, and ii) forming the cellulosic molded body from the treated cellulose-comprising starting material.

According to a further aspect of the present invention, a use of a continuous boiling aggregate for continuously treating a cellulose-comprising starting material (in particular used textiles) with a predefined composition is described.

In the context of this document, the term “cellulose” may in particular denote an organic compound which is a constituent of plant cell walls or may be manufactured synthetically. Cellulose is a polysaccharide (i.e. a multiple sugar). Cellulose is unbranched and typically comprises multiple hundred up to ten thousands β-D-glucose molecules (β-1,4 glycosidic bond) and cellubiose-units, respectively. From cellulose molecules, cellulose fibers are built by plants in a controlled manner. With a technical process, glucose molecules may be agglomerated under formation of regenerated fibers, for example as tearproof fibers.

In the context of this document, the term “molded body” may in particular denote a two- or three-dimensional geometric body which is a result of a method for manufacturing and recovering, respectively, of cellulose. In particular, molded body may denote a two- or three-dimensional object which comprises or consists of cellulose and is manufactured from solved pulp. In particular, molded bodies may be lyocell-molded bodies; viscose-molded bodies, modal-molded bodies, or paper-molded bodies (paper tissue). Typical molded bodies are filaments, fibers, sponges and/or films. Basically; all types of cellulose molded bodies are suitable for embodiments of the invention. Both, endless filaments and cut staple fibers with conventional dimensions (for example 38 mm length) and short fibers are denoted as fibers. For manufacturing fibers, both, methods with withdrawing units subsequently to one or more extrusion jets, and other methods, such as in particular melt-blowing-methods, may be used. Alternatively to fibers, also a cellulose-comprising foil may be manufactured as molded body, i.e. a planar and substantially homogenous film with or made of cellulose. In particular, foils may be manufactured by adjusting the process parameters of a lyocell method, such that coagulating is triggered at least partially only after an impingement of the filaments on a receiving surface. Foils may denote planar cellulose molded bodies, wherein the thickness of these foils is adjustable (for example by selecting a number of serially arranged jet bars). Other embodiments of a molded body are a tissue and a fleece made of cellulose filaments and made of cellulose fibers, respectively, in particular a spinning fleece made of integrally merged (“merging”) substantially continuous cellulose filaments (“melt blown”). A tissue may in particular denote a textile planar web made of at least two crossed (preferably in a perpendicular or almost perpendicular manner) thread systems (or fiber systems), wherein threads (or fibers) in the longitudinal direction may be denoted as warp threads and threads (or fibers) in the cross direction may be denoted as weft threads. A fleece or nonwoven may be denoted as orderless web (which is in particular present in tangles) made of filaments or fibers or cut yarns of a restricted length, which are merged (in particular in a frictionally engaged manner) to a fiber layer or a fiber gauze. A molded body may also be created in the shape of a sphere. Also cellulose-comprising particles, in particular such as beads (i.e. a granulate and spheres, respectively) or flakes may be provided as molded bodies, which may be further treated in this form. Possible cellulose molded bodies are also particulate structures, such as granulate, spherical powder or fibrids. A shaping of a molded body is preferably performed by an extrusion of a cellulose-containing spinning solution through an extrusion nozzle, since in this way large amounts of the cellulose molded bodies with a very uniform shape may be manufactured. A further possible cellulose molded body is a sponge or, more general, a porous molded body. According to exemplary embodiments, the mentioned molded bodies may be used for manufacturing yams, textiles, gels, paper, cardboard, filters, or composite materials, for example.

In the context of this document, the term “lyocell-method” in particular may denote a method for manufacturing cellulose according to a direct-solvent method. The cellulose for the lyocell-method may be obtained from a starting material which comprises this cellulose. In the lyocell-method, the starting material may be solved in a suitable solvent (in particular comprising tertiary amine oxides, such as N-methylmorpholine-N-oxide (NMMO) and/or ionic liquids, i.e. low melting salts, which are made of cations and anions). In particular, solving may be performed by dehydration and/or without chemical modification. In the lyocell-method, the obtained solution, which may also be denoted as dope or spinning solution, may subsequently be pressed through one or more spinning jets. Filaments which are formed thereby may be precipitated during and/or after their free or controlled fall through an air gap in a water-containing bath (in particular in a bath with aqueous NMMO-solution) and/or in air humidity which is present in the air gap.

Lyocell denotes a cellulose-comprising type of regenerated fiber which is manufactured according to a direct-solvent method. The cellulose for the lyocell-method is extracted from the raw material wood. The thus obtained pulp may subsequently be solved in N-methylmorpholine-N-oxide (NMMO), a solvent, by dehydration without chemical modification, filtered, and subsequently pressed through spinning nozzles. The filaments which are formed in this way are precipitated after passing an air gap in a bath with aqueous NMMO-solution; and are subsequently cut, e.g., to staple fibers.

In the context of this document, the term “viscose method” may in particular denote a method for manufacturing cellulose according to a wet spinning method. For the viscose method, the cellulose may be obtained from a starting material (in particular wood or a wood pulp) which comprises this cellulose.

In the context of this document, the term “viscose method” may denote a xanthogenate method. In the viscose method, which is performed as xanthogenate method, in subsequent process stages, the starting material may at first be treated with a base (for example with caustic soda lye), whereby alkali cellulose is formed. In a subsequent conversion of this alkali cellulose with carbon disulfide, cellulose-xanthogenate is formed. From this, by adding a base (in particular caustic soda lye), a viscose-spinning solution may be generated which may be pressed through one or more spinning nozzles. In a spinning bath; viscose-filaments are generated by coagulation. The thus manufactured viscose-filaments are subsequently cut, e.g. to viscose-staple fibers.

In the context of this document, the term “viscose method” may also denote a carbamate method, wherein instead of carbon disulfide, ammonia is used for manufacturing a soluble cellulose derivate. Instead of the cellulose-xanthogenate, so-called cellulose-carbamate is generated. Analog to the further use of the cellulose-xanthogenate, from the cellulose-carbamate, a spinnable solution is manufactured from which, after pressing through one or more spinning nozzles, cellulose-filaments may be regenerated in a spinning bath.

Furthermore, in the context of this document, the term “viscose method” may also denote a cold alkaline method, wherein cellulose is solved without further derivatizing to the xenthogenate or carbamate in a tempered; in particular cooled; aqueous alkaline medium. In an embodiment, the temperature of the aqueous alkaline medium is less than 20° C., in particular also less than 5° C. For improving the solving behavior, additives may be added to the aqueous alkaline medium, such as urea, thio urea, zinc oxide, polyethylene glycol, or tensides. Again, from the cellulose-containing spinning solution, cellulose-filaments are regenerated after passing through one or more spinning nozzles, by precipitating in an acidic or alkaline spinning bath.

Chemical fibers and regenerated fibers, respectively, are denoted as viscose fibers, which are manufactured by a wet spinning method which is called viscose method (in particular a xanthogenate method, a carbamate method, or a cold alkaline method). The starting raw material of the viscose method is a highly pure cellulose in form of chemical pulp.

In the context of this document, the term “remains from a clothing manufacture” may in particular denote rejects and/or cutting waste (German: Verschnitt) of a textile or yarn which comprises or consists of cellulose, wherein these remains occur during a method for manufacturing clothing. When manufacturing clothing, for example a cellulose-comprising textile is manufactured as starting material, from which planar portions (for example with a shape of a T-shirt half) are subsequently cut. Remains remain, which, according to an exemplary embodiment, may be resupplied to a method for manufacturing a cellulose-comprising molded body. Thus, residues from a clothing manufacture may be a starting material which comprises or consists of cellulose, which may be used for a recovery of cellulose, before a user has used the remains as clothing or in another way. In particular, remains from a clothing manufacture may substantially be made of pure cellulose, in particular without foreign matters which are separate and do not comprise cellulose (such as buttons, textile print or seams).

In the context of this document, the term “used clothes” may in particular denote cellulose-comprising clothing and/or home textiles (e.g. bed clothes), which are already used (in particular worn) by a user when recovering at least a part of the cellulose. Thus, used clothes may be a cellulose-comprising starting material which may (but does not have to) comprise significant amounts of foreign matters, and may be used for recovering cellulose, after a user has used the used clothes as clothing or in another way. In particular, used clothes may be made of a mixture of cellulose and one or more foreign matters, in particular comprising (in particular in clothing frequently used) synthetic plastic (such as polyester and/or elastane) and/or foreign matters which are separate and do not comprise cellulose (such as buttons, textile print or seams). Polyester in particular denotes polymers with ester functions (R—[—CO—O—]—R) in their main chain. Polycarbonates and polyethylene terephthalate belong to polyesters. Elastane in particular denotes a stretchable chemical fiber with a high elasticity. A block copolymer on which elastane is based may contain a mass portion of at least 85% polyurethane.

In the context of this document, the term “used textiles” may denote both “used clothes” and “remains from a clothing manufacture”.

In the context of this document, the term “textiles” may denote both “new textiles” and “used clothes” and “remains from a clothing manufacture”.

The term “new textiles” encompasses textile raw materials (natural fibers, chemical fibers), and non-textile raw materials which were processed by one or more methods to line-, plane-shaped, or spatial products. The term “new textiles” may correspond to the term “rejects from the clothing manufacture”, and may also denote finished products (e.g. clothes, bed clothes), wherein the latter was substantially not used/worn by a user yet. In an embodiment, it is differentiated between used textiles and new textiles. In another embodiment, the term used textiles may also encompass these new textiles (finished textile products which are not used may be also denoted as used textiles and/or clothing rejects).

In the context of this document, the term “paper manufacture” may in particular denote, that from a cellulose-containing and treated starting material, a cellulosic molded body is formed, which is then further processed to a paper product. All processing stages which lead from a cellulose-containing starting material to a paper tissue may thus be denoted as paper manufacturing method. Furthermore, all processing stages which lead from the paper tissue to a paper product may be denoted as paper manufacturing.

A “paper tissue” may be denoted as paper starting material in this context, from which a paper product, such as a paper, a cardboard, a filter or the Ike may be formed. A paper tissue may be a composite material which contains at least pulp (cellulose) and a binder. The paper tissue may be present in solid form, but also as a suspension, e.g. in water. In a broader sense, a “paper tissue” may also encompass the paper product itself. Furthermore, a paper tissue may also encompass paper or materials which are similar to paper, such as cardboard, filter material; isolation mats, absorbing fleeces, fiber reinforced planar materials etc. Paper tissue may be formed by dehydration of a fiber suspension, e.g. on a sieve. The paper tissue may be further compacted and dried in following process stages. However, a paper tissue may also be a planar material (fiber fleece) which substantially consists of (cellulose-) fibers.

In the context of this document, the term “treating” may in particular denote, that an incoming starting material is processed (treated), such that an outgoing, treated starting material in its chemical/physical properties and in its material composition, respectively, at least partially differs from the incoming starting material. During a treatment process, for example a boiling process, in particular an alkaline boiling, may be performed. Furthermore, during a treatment process, synthetic fibers, such as polyester, may be depleted from the cellulose (by boiling), for example. Moreover, a treatment process may also encompass mechanical separation stages, such as density separation. Alternatively or additionally to the boiling process, e.g. synthetic fibers or other foreign matters may therefore be mechanically removed.

In the context of this document, the term “boiling process” may in particular denote a chemical process which serves for a recovery of pulp (cellulose) from a cellulose-containing starting material. Also denoted as “boiling”, in a boiling process under influence of temperature and/or pressure impact, the starting material may be decomposed in a reactor device. In this context, the term “reactor device” may denote each device which enables to perform a boiling process described in this document. For example, the reactor device may comprise a boiling aggregate (e.g. a Pandia boiler). In this context, a boiling aggregate (boiler) may also be denoted as digester. In an embodiment, a boiler may comprise a transport unit, e.g. a conveying screw (extruder) and/or a conveying belt (conveyor), to (continuously) transport the starting material through the boiler. A boiling process may be alkaline or acidic. In particular, an alkaline boiling process may lead to saponification of plastics, such as polyethylene terephthalate (PET), polyamide (PA), or polyurethane (PUR). According to an embodiment, a boiling solution may be used which does not decompose the cellulose. For example, an alkaline boiling may be performed with sodium hydroxide (NaOH), to degrade (residual) polyester, and to optionally adjusts the chain length of the cellulose molecules.

With respect to the decomposition of wood chips, the following boiling processes are especially frequently used, which may also be used for used textiles, for example:

i) a sulfate method (also denoted as sulfate decomposition or -process, and/or also denoted as kraft-method due to the more solid fibers). The active substances may be caustic soda and sodium sulfite (sodium sulfite (Na₂SO₄) may be used for the recovery). The starting material (e.g. wood chips) may be impregnated with the boiling lye and may be supplied to a boiler. At a temperature of up to 170° C., for example, wood constituents, such as hemicelluloses and lignins, may be transferred to soluble forms. A degradation of the cellulose fibers may be undesired;

ii) a sulfite method for which e.g. liquid sulfur dioxide may be used. The acidic sulfite process may solve the composite between lignin and cellulose by sulfonation and ether splitting of the lignin.

In the context of this document, the term “supplying” may in particular denote that a starting material with a predefined composition is provided. The starting material may be a solid matter (such as used textiles) and may be directly supplied to a reactor device (e.g. after a comminuting stage and/or shredding). However, the starting material may be a solid matter and may be supplied to the reactor device after an additional solving stage in at least partially solved form. In the context of this application, the term “discharging” may in particular denote that a treated starting material is removed from a reactor device after a treatment stage. The treated starting material may be present in a solved form (e.g. in a solvent) or as solid matter. Supplying and/or discharging may be performed continuously.

In the context of this document, the term “continuously” may in particular denote, that a technical process is performed without interruptions. In other words, a (continuous, “steady-state”) long-lasting material flow (which comprises at least the stages i) supplying, ii) treating; and iii) discharging) may be performed which is substantially not interrupted. In contrast, a discontinuous process is frequently interrupted, since a treatment is performed batchwisely (respectively chargewisely). In the continuous process, supplying and discharging may also be performed continuously. For example, a reaction device may be formed at least partially tube-shaped, such that the starting material is continuously supplied to a first opening, and treated starting material may be continuously discharged from a second opening, while in between continuously treating and moving takes place (e.g. hydrostatically or by a conveyor screw).

In the context of this document, the term “predefined composition” may in particular denote an amount and/or a concentration of at least two composition components in a starting material. For example, the starting material may be a used textile and the components may be cellulose fibers and synthetic fibers. In this case, the concentration and/or a concentration range may be respectively predefined for cellulose fibers and synthetic fibers, to therefore provide a predefined composition. The defined composition may encompass absolute values or value ranges.

In the context of this document, the term “synthetic fiber” may in particular denote a fiber which comprises or consists of one or more synthetic plastics. The term “synthetic plastic” may in particular denote a material which is made of macromolecules and is manufactured synthetically. The respective macromolecules of a plastic are polymers and are therefore made of repeating basic units (repeating units). The size of the macromolecules of a polymer may vary between some thousands up to more than one million basic units. For example, the polymer polyethylene (PE) consists of connected, multiply repeating ethylene units. The polymers may be unbranched, branched, or cross-linked molecules. With respect to their physical properties, plastics may be principally classified into three groups: thermoplast, thermosetting plastic (German: Duroplast), and elastomers. Furthermore, these properties may also be combined in subgroups, e.g. in case of thermoplastic elastomers. Important features of plastics are their technical properties, such as formability, hardness, breaking strength, temperature-, heat resistance, and chemical resistance, which may be broadly varied by the selection of the macromolecules, manufacturing methods and typically by adding additives. Typical reactions for manufacturing synthetic plastic from monomers or pre-polymers are: chain polymerization, polyaddition, or polycondensation. Examples for synthetic plastics which are in particular also used in textiles, are e.g. polyurethane (PUR), in particular as constituent of elastane, polyester (PE, e.g. polyethyleneterephtalate (PET)), polyamide (PA, e.g. nylon, perlon), and polyether, in particular polyethylene glycol (PEG) as constituent of elastane.

In the context of this document, the term “elastane” may in particular denote a synthetic plastic which comprises thermoplastic and elastic properties. Elastane may therefore be denoted as thermoplastic elastomer (TPE). Elastane may be present as block copolymer which is in particular characterized by the following both blocks: polyurethane (PUR) and polyethylene glycol ether (PEG). The PUR segments may form stiff sections, which alternate with soft, elastic PEG sections. PUR may form stiff, elongated sections which attach to each other in a lengthwise manner and enable the cohesion, e.g. of a fiber, by forming secondary valence forces. In contrast, the rubberlike PEG blocks (e.g. respectively approximately 40 to 50 monomer units) may be present in a highly entangled manner, wherein they may nevertheless be stretched. Elastane may be present as frizzle structure (German: Kräuselstruktur) with a very high stretchability (multiple 100%, e.g. 700%). The density may be between e.g. 1.1 and 1.3 g/m³ and the rigidity may be between 5 to 12 cN/tex, for example. The elasticity may be temperature-dependent. Furthermore, the term “elastane” may denote elastane itself, and also related thermoplastic elastomers (e.g. elastollan, desmopan, texin, and utechllan).

According to an exemplary embodiment of the invention, an especially efficient, robust, and resource saving method for manufacturing a treated cellulose-comprising starting material is provided by performing a continuous treating process, to which a cellulose-comprising starting material (a solid matter, in particular used textiles) is supplied in a predefined composition. A continuous manufacturing process (in particular a boiling process) may be realized in a manner which is process-technically simpler than a discontinuous process. For example, a large aggregate (e.g. a reactor device, such as a boiler) may be utilized instead of many small aggregates. Thereby, the need of measurement and control technology may be significantly reduced. In a continuous treatment process, a steady flow (“steady state flow”) may be generated, i.e. inlet- and outlet stream may be coordinated as a steady flow. This may be controllable in an operatively especially proper manner. By the continuous mode of operation, a higher throughput as in a discontinuous process may be achieved, since “rest times” (e.g. filling a reactor, heating, evacuating, cleaning) are omitted. The continuous operation thus enables a compact architecture.

Moreover, the continuous process may be performed in a manner which is significantly more resource saving, durable, and ecological, since the energy (e.g. steam) consumption may be reduced. For example, the boiler does not have to be reheated with each batch (as in a discontinuous method), but operates (heats) continuously. Also due to a more efficient utilization with respect to the plant architecture, energy may be saved. Furthermore, the described process may also be efficiently combinable with subsequent processes (for example a bleaching process) which may then also be continuously operated.

A continuous boiling process could have disadvantages. Thus, the process conditions (e.g. staying time, temperature) are specified in a defined range. Therefore, it is not possible to flexibly/dynamically react to changes in the raw material quality and/or the material composition. Thus, no individual treatment of single starting materials may be possible.

According to an exemplary embodiment of the invention, these possible disadvantages are overcome by the fact that the solid starting material is (exclusively) provided with a predefined composition. This predefined composition may be e.g. a special mixture/composition made of used textiles. Instead of always (respectively batchwisely) re-adapting the process to the material composition of the starting material (as in the case of the discontinuous method), it has surprisingly turned out, that instead, the material composition of the solid cellulose-comprising starting material may be adapted to the process in a highly efficient and robust manner (continuous method). For example, incoming deliveries of used textiles may be selectively enriched and/or depleted, such that the total composition corresponds to the predefined composition. E.g. the amounts of cellulose and synthetic plastic in the starting material may be adjusted to exactly defined concentrations. These concentrations may be further subjected to predefined variation ranges, such that a continuous treatment process is enabled which requires significantly less complex measurement and control technology. Thus, savings may mainly result from the decreased regulation requirement (one aggregate with a high capacity in the continuous operation instead of multiple small aggregates with small capacity in the discontinuous batch operation).

The stage of flexibly adapting may thus be shifted forwardly, whereby the total manufacturing method in the continuous mode of operation becomes more efficient and robust.

In the following, additional embodiments of the methods and the use are described.

According to an embodiment, the cellulose-comprising starting material entirely or partially comprises remains from a clothing manufacture and/or used clothes. This may have the advantage, that used textiles may be recycled in a very efficient manner. With the described method, used textiles which typically are a very inhomogenous mixture, may be efficiently supplied to a continuous manufacturing process. Due to the fact that the used textiles-mixture are subject to a predefined composition, a continuous treatment of the stream of supplied used textiles as cellulose-containing starting material may be enabled.

In this context, embodiments of the invention may relate to the technical field of reusing (recycling), in particular recycling of used textiles. The used textiles may respectively comprise cellulose and optionally at least one synthetic plastic, and may thus be used as cellulose-containing starting materials. Thus, used textiles may be recycled as starting material with a predefined composition for continuously manufacturing a (regenerated) cellulosic molded body, in particular wherein the cellulose of the regenerated molded body is substantially present in form of lyocell fibers, viscose fibers and/or paper fibers.

In a further embodiment, a presorting may be performed upstream with respect to the treatment of the material composition of the utilized used textiles mixture. Typically, used textiles may be delivered in a hardly definable (inhomogenous) mixture. Used textiles may be preselected by mechanically, also manually, presorting for removing completely unusable amounts of e.g. cotton, metal foils, plastic fleeces, etc.

According to an embodiment, remains from a clothing manufacture may be mixed with used clothes, to provide the predefined composition. Remains from a clothing manufacture may be e.g. production waste from the industry and are thus frequently identifiable and partially homogenous. By combining these both (recycling-) streams, an advantageous used textiles mixture may be provided. It may be especially suitable for the manufacture of a cellulosic molded body, e.g. a lyocell molded body.

According to an embodiment, the method further comprises adjusting the predefined composition (in particular by specifically mixing different inlet streams with a known composition). Adjusting may comprise: i) selectively enriching at least one composition component, and/or ii) selectively depleting at least one composition component. This may provide the advantage, that the predefined composition may be obtained in a fast and robust manner.

The starting material may be a mixture of two or more composition components, e.g. a used textile mixture with cellulose fibers and synthetic fibers. Composition components may also be clothing remains or used clothes of a certain type. For example, a pure cotton shirt may be one composition component, while the sportswear which mainly consists of polyester, may be a further composition component. To obtain a predefined composition, charges with known compositions (known amounts of composition components) may be mixed, such that the mixture comprises the predefined composition. As described above, e.g. (cutting waste) residues from the clothing production may comprise a known composition. Furthermore, the composition, e.g. of a mixture, may also be determined in different ways, e.g. by a skilled operator or by, in particular optical, automatic measuring methods. Based on the determined composition, further used textile and/or clothing remains (as composition components) may be added, to obtain the predefined composition. According to an embodiment, used textiles with a very high cotton content may be added, to increase the cellulose content. Additionally or alternatively, composition components may be also removed from the starting material. For example, specifically sportswear may be removed which comprises an especially high amount of polyester. For fine adjustments, the mentioned remains from a clothing manufacture which may comprise defined compositions, may be especially suitable.

According to a further embodiment, depleting of the method further comprises: at least partially (selectively) remaining a synthetic plastic in the starting material. In particular, the synthetic plastic may be one of the group which is consisting of polyamide, polyester, polyurethane, and elastane. This may have the advantage, that a synthetic plastic does not have to be depleted especially dean and/or pure. Depleting small residue concentrations may in fact be technically challenging and resource intensive.

Instead, synthetic plastic, e.g. polyurethane, may remain in the mixed textile, whereby elaborate and cost intensive depleting processes may be reduced and/or are not required anymore. When at least a part of the polyurethane is assigned to elastane, additionally even further advantages may be achieved, such as an improvement of the rigidity values and/or the elasticity of the molded body to be manufactured.

Low amounts (e.g. below 2%) of e.g. polyamides and polyesters may be co-processed in the recycling method, to achieve a good embedding in cellulose. In a recycling method, this may be a significant advantage, since at least partially removing further synthetic polymers, in particular in low concentrations, may be disproportionally elaborate. The above mentioned further synthetic plastics may be contained in starting materials, such as textiles, very frequently and commonly. Therefore, an acceptance of low residual amounts is a massive facilitation of a recycling method.

According to a further embodiment, continuously treating further comprises: performing a continuous boiling process, in particular using an alkaline boiling solution, further in particular a sodium hydroxide-containing boiling solution. This may provide the advantage, that robust and approved techniques may be directly applied.

When wood chips are used as solid starting material, a boiling in a strong disintegrating agent/reaction medium such as sodium hydroxide and sodium sulfide, may enable the solving of lignin, to separate it from the cellulose. When used textiles are used as solid starting material, in this way, synthetic plastic may be solved, to obtain the cellulose in a form which is as pure as possible and/or with a desired residual concentration of polymers. In particular, a boiling process, in particular with NaOH (sodium sulfide is not necessary, since used textiles do not contain lignin), may lead to a saponification of plastics, such as PET, PA, or PUR, while the cellulose is not degraded.

According to a preferred embodiment, the alkaline boiling may be performed as follows: the fibers, in particular already enriched cellulosic (or mainly cellulosic) fibers, may be treated with an alkaline solution (for example sodium hydroxide or potassium hydroxide) in combination with a gaseous oxidizing agent (for example 0₂) in a boiler (e.g. a pressure vessel) (preferably at a pH value of at least 9), namely:

a) at a temperature between 90° C. and 185° C.;

b) for an incubation time of 45 minutes to 270 minutes;

c) in the presence of a cellulose stabilizing additive (for example a magnesium salt, preferably magnesium sulfate; or a chelating compound on basis of a transition metal, for example ethylenediaminetetraacetic acid (EDTA)), preferably in a concentration in a range between 0.01 weight percent and 5 weight percent with respect to the supplied fibers;

d) at an alkali-concentration in a range between 1 weight percent and 35 weight percent with respect to the supplied fibers;

e) at an initial gas pressure in a range from 1 bar to 21 bar (corresponding approximately 0.1 MPa to approximately 2.1 MPa).

The generated solved pulp may subsequently be subjected to a washing procedure.

In particular, supplying the alkaline solution for degrading non-cellulosic fibers may be performed, in particular synthetic fibers, further in particular polyester fibers. Especially polyester may be thereby split into water-soluble constituents, which may be separated from the cellulose fibers by the wastewaters which occur in the process. In this procedure, for example polyester may be split into the monomers ethylene glycol and terephthalic acid. These are water-soluble and, according to an embodiment, may be separated from the cellulose fibers via process waste lyes (German: Prozessablaugen). Parallel to the polyester degradation, also cellulose degrading reactions may take place in this boiling process. By a suitable selection of the process parameters, according to an embodiment of the invention, the cellulose degradation may be controlled, such that a certain target degree of polymerization is adjusted. This is advantageous, since the degree of the cellulose polymerization (expressed as limiting viscosity number) is frequently a specification criterion for chemical pulp.

In the following, some embodiments of the predefined composition are described. They may have the advantage, that continuously providing the treated starting material is efficiently enabled by the fact that also the process conditions may be kept stable over a long period. In order to quantify the predefined composition, concentrations as well as fluctuation ranges of the composition components may be used.

In the context of this document, the term “fluctuation range” may denote a deviation from a predefined value and/or a reference value. The fluctuation range may be an absolute value or a relative value. The fluctuation range may also denote a standard deviation.

Overview of the composition of the raw materials in % (pure fiber amount without foreign matters, such as buttons etc.)

| Type | Basis | Preferred | Esp. preferred |
|---|---|---|---|
| Cellulosic fibers | >60 | >80 | >92.5 |
| Polyester | <30 | <16 | <5 |
| Polyamide | <4 | <1 | <0.5 |
| Polyacrylic | <1 | <0.5 | <0.1 |
| Elastane(like) | <5 | <2.5 | <1 |

Tolerable fluctuation range: for cellulosic fibers and polyester±2.5%, preferred±1%, especially preferred<±0.5%. For polyamide, polyacrylic, and elastane±0.5%, preferred±0.1%, especially preferred<±0.05%.

According to a further embodiment, the predefined composition comprises cellulosic fibers. Furthermore, the predefined composition of the cellulosic fibers comprises a fluctuation range of 2.5% or less, in particular of 1% or less, further in particular of 0.5% or less.

According to a further embodiment, the predefined composition comprises synthetic fibers, in particular polyester fibers. Furthermore, the predefined composition of the synthetic fibers, in particular of the polyester fibers, comprises a fluctuation range of 2.5% or less, in particular of 1% or less, further in particular of 0.5% or less.

According to a further embodiment, the predefined composition comprises further synthetic fibers. Furthermore, the predefined composition of the further synthetic fibers comprises a fluctuation range of 0.5% or less, in particular of 0.1% or less, further in particular of 0.05% or less. In particular, the further synthetic fibers comprise at least one of the group, which is consisting of: polyamide, polyacrylic, and elastane.

According to a further embodiment, the predefined composition comprises 60% or more, in particular 80% or more, further in particular 92.5% or more, cellulosic fibers. Additionally or alternatively, the predefined composition comprises 30% or less, in particular 16% or less, further in particular 5% or less, synthetic fibers, in particular polyester fibers.

According to a further embodiment, the predefined composition comprises at least one of the following features:

i) the predefined composition comprises 4% or less, in particular 1% or less, further in particular 0.5% or less, polyamide;

ii) the predefined composition comprises 1% or less, in particular 0.5% or less, further in particular 0.1% or less, polyacrylic;

iii) the predefined composition comprises 5% or less, in particular 2.5% or less, further in particular 1% or less, elastane.

According to a further embodiment, the reactor device comprises a continuous boiler. This may have the advantage, that established and approached technology may be directly used for the described method.

Different boiler systems are known to a skilled person, e.g. Pandia, Sprout-Waldron, Escher-Wyss, and Kamyr. These and further may be directly used for the described method as continuous boilers. With a Kamyr-boiler, a sulfate- or sulfite process may be performed, for example, wherein in the inlet region a temperature of 110° C., in the center region a temperature of approximately 140° C., and in the outlet region a temperature of approximately 80° C. is present.

According to a further embodiment, the method further comprises: performing a continuous post process, in particular a bleaching process, after continuously discharging. This has the advantage that, in a flexible manner, further treatment processes may be performed subsequently to treating and may thus be also continuously operated.

Continuous post processes may encompass certain cleaning stages or drying a pulp-mass (German: Pulpe), for example. Furthermore, a post process may encompass bleaching. The latter in particular in the case, when for manufacturing a cellulosic molded body from the treated starting material, a paper tissue is provided. A process may be denoted as bleaching, which removes or attenuates undesired colorings. In bleaching, bleaching agents are used, which are oxidizing or reducing compounds, which should be at least partially selective. For example, bleaching agents may attack coloring substances by destroying the chromophores. As bleaching agents, e.g. oxygen, ozone, hydrogen peroxide, chlorine-compounds (e.g. chlorine dioxide or hypochlorite), but also enzymes may be used.

Bleaching may comprise at least one of a group which is consisting of oxidative bleaching, reductive bleaching, and enzymatic bleaching. According to a preferred embodiment of the invention, bleaching may comprise performing an acidic washing, followed by performing an ozone bleaching, in turn followed by performing a peroxide bleaching. By bleaching, colorants and other chemical residual substances in the recycled textile materials may be removed.

According to a further embodiment, forming the cellulosic molded body from the treated starting material comprises one of the group, which is consisting of: a lyocell method, a viscose method (in particular a xanthogenate method, a carbamate method, or a cold alkali method), a paper manufacturing method. This may have the advantage, that especially efficient and approved methods may be directly applied to the treated starting material, to manufacture a cellulosic molded body.

The molded bodies which are manufactured according to embodiments of the invention may be used as packaging material, fiber material, textile composites, fiber fleeces, needle felts; cushion wadding, tissue, paper tissue, paper product, paper, cardboard, filter, knitted fabrics, as home textiles, such as bed clothes, as clothing, as filling material, flocking substance, hospital textiles, such as underlays, diaper, or mattresses, as substance for heating blankets, shoe inlays, and wound dressings, for example. Embodiments of the invention may be applicable in different technical fields and in medicine and cosmetics and wellness. In medicine, materials for wound treatment and wound healing may be made of a carrier which determines the mechanical properties, and a biocompatible coating material, which is especially compatible with the skin and with the surface of the wound, for example. Many other applications are possible.

In the following, exemplary embodiments of the present invention are described in detail with reference to the following figures.

### DETAILED DESCRIPTION OF EXEMPLARY EMBODIMENTS

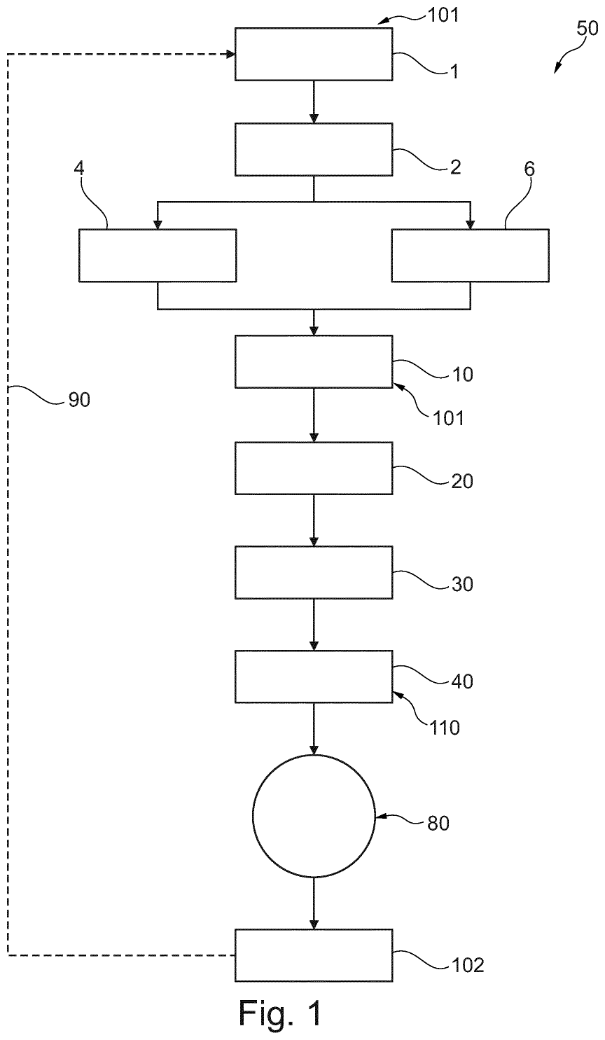

FIG. 1 shows a flow diagram of a method for continuously providing a treated starting material according to an exemplary embodiment of the invention.

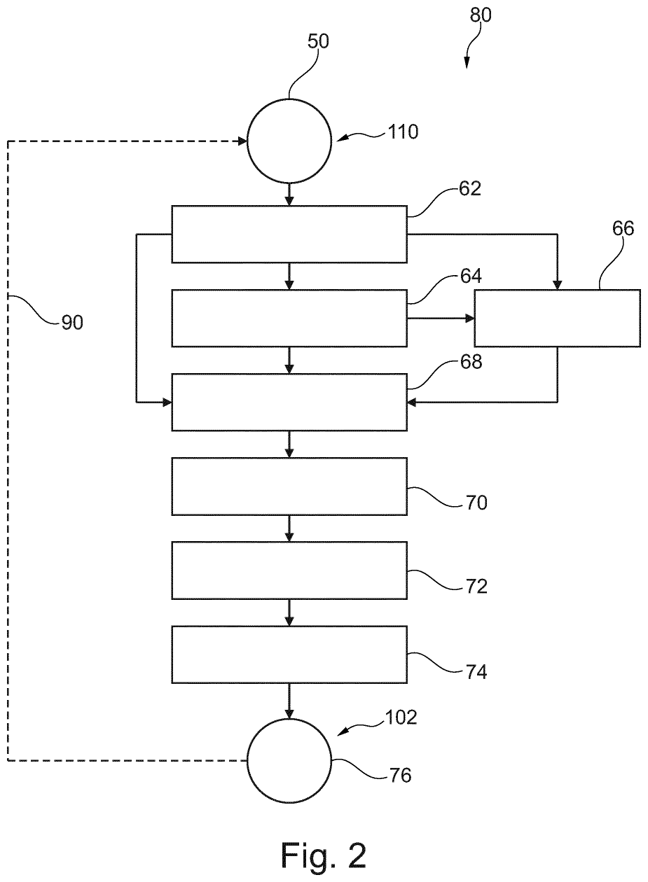

FIG. 2 shows a flow diagram of a method for manufacturing a regenerated cellulosic molded body from the treated starting material, according to an exemplary embodiment of the invention.

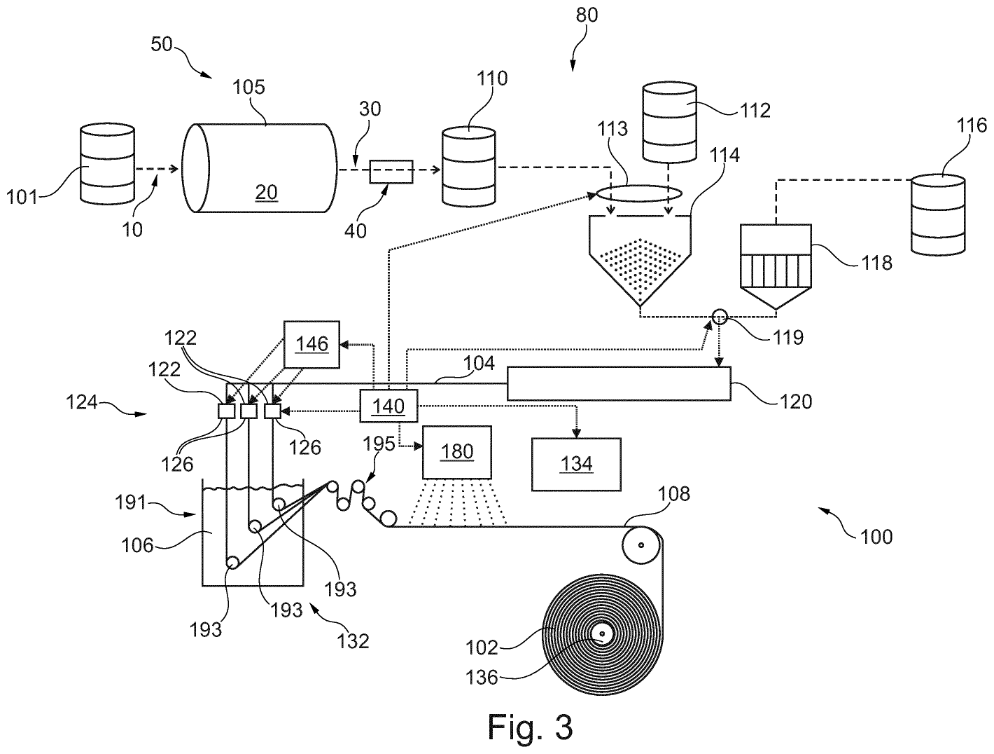

FIG. 3 shows a device for providing the treated starting material and for manufacturing a regenerated cellulosic molded body by a lyocell method from the treated starting material according to an exemplary embodiment of the invention.

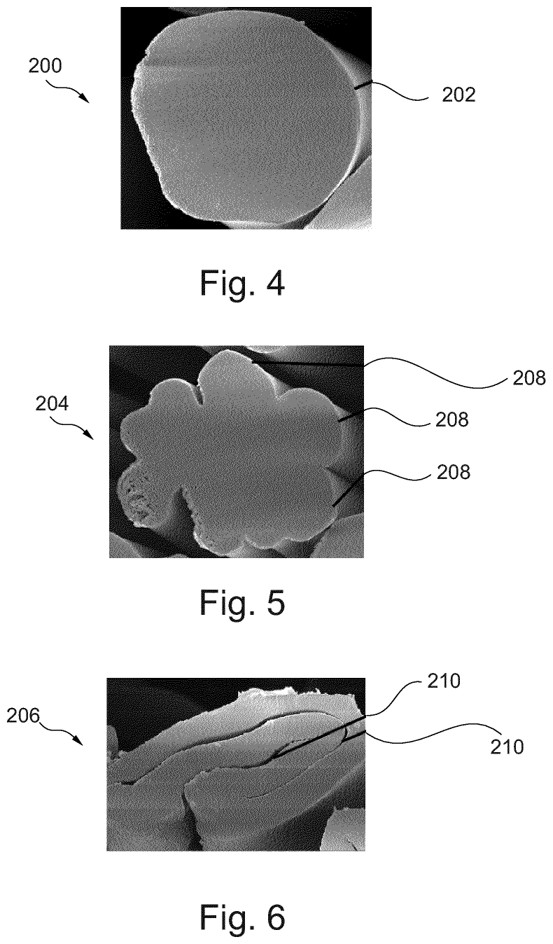

FIG. 4 shows a cellulose fiber which is manufactured by a lyocell method.

FIG. 5 shows a cellulose fiber which is manufactured by a viscose method.

FIG. 6 shows a natural cellulose fiber from a cotton plant.

Same or similar components in different figures are provided with the same reference numbers.

Before exemplary embodiments are described with reference to the figures, some basic considerations shall be summarized, based on which exemplary embodiments of the invention are derived.

According to an exemplary embodiment, in the manufacture of a suitable used textile mixture (predefined composition), it is proceeded as follows, for example: from a raw (still untreated) used textile mixture with a high amount of cotton or cellulose fibers (e.g. viscose, lyocell) and synthetic polymer fiber amounts (e.g.: PP, PET, PA, PUR-TPE), by shredding, flotation, selectively solving, boiling, or other standard processes in large industrial scale, a treatment is performed, wherein a 100% removal of undesired constituents is very elaborate. Therefore, the following material mixture according to embodiments of the invention was determined: 1) the amount of non-textile additional materials from the list (buttons, rivets, clips, eyelets) is below 0.1%, the amount of polyamide is below 0.1%, the amount of PTFE is below 0.1%, the amount of polyester (PET) is below 30%, the amount of polyolefins (PE and preferably PP) is below 1%, the amount of TPE on basis of PEG-PUR is below 10%, the amount of polyacrylic nitrile (PAN) is below 1%, residual constituents are mainly cellulose-based textiles; or 2) more than 60% cellulose, below 10% PET, preferred below 5%, even more preferred below 2%, below 15% PUR-TPE with soft segments made of polyolefin ethers or aliphatic esters (elastane), below 5% PA, addition of more than 0.1% AO-stabilizer for preventing the oxidative integration of desired polymers to undesired oligomers (which would induce negative product properties, such as instable mechanical properties, brittleness, tendency to color change, etc.).

According to an exemplary embodiment, the following details in the manufacture of the substance mixture of the addition in the NMMO-solution are considered: used textiles which are available for recycling are selected due to the following characteristics and are treated and supplied, e.g. to the lyocell process, as constituents of the substance mixtures in a suitable form: a) reduction to the textile parts (therefore removal of buttons, rivets, zip fasteners, hook and loop fasteners, applications etc.); b) specific selection or amount determination for a subsequent proportional combination of the substance streams of the following fiber constituents: i) cellulosic fibers: these are desired, they differ from each other by molecular weights and therefore solubility in NMMO (viscosity), adjustment and adaption by an alkaline treatment. In the ideal case, these materials constitute 100% of the recyclate textiles. These materials encompass cotton, viscose, lyocell, linen, etc.; ii) polyamides: insoluble in NMMO, degradation by acidic hydrolysis. In typical raw used textile mixtures, cotton is contained by up to 80%, polyamides up to 25%, in certain tissues, which may be simply selected by sorting (sweater, “cotton character”). There is no real possibility for a removal by selectively solving. To these materials belong cotton, silk, synthetic polyamide PA6 and PA6.6 (nylon, perlon); iii) polyester: insoluble in NMMO, degradation by alkaline hydrolysis with recovery of the acidic portion, possibility for separation by selectively solving. Recycling amounts up to 30% in tissues. To these materials belong e.g. PET and elasto-polyester; iv) polyolefins: insoluble in NMMO, no possibility for degradation by hydrolysis, but separation by selectively solving. Low content in delivered recycling tissues (below 1%). To these materials belong e.g. PP as fiber and PE as hot melt adhesive in fleeces; v) others: PEG-PUR up to 5% soluble in NMMO, up to 10% in tissues, PAN insoluble in NMMO, both degradable by intensive (German: scharfe) acidic hydrolysis. PTFE: insoluble and not degradable. In most cases handable by sorting (e.g. anoraks). To these materials belong e.g. PEG-PUR (elastane, Lycra, spandex), polyacrylic nitrile (PAN), PTFE (Gore-Tex).

According to a further exemplary embodiment, residual polymers from starting materials are used as adhesion promoter among cellulose fibers or as thermoplastic property promoter within a lyocell molded body. They remain substantially inert until finishing a certain stage in the production process. In particular, a subsequent stiffening of a tissue by heat (analog to hot melt adhesive) may thus be achieved (e.g. non-iron shirts, pleating, etc.). For manufacturing tissues which have the property of a high dimensional stability (e.g. non-iron), an elaborate method is typically used. This may be the combination of very elaborate chemical methods, for example. It makes a shirt looking new for a long time. Also the so-called “humid cross-linking” is possible, wherein an elastic bridge is formed between the molecules of cotton cellulose. This bridge pulls the tissue in form again after washing.

By the specific control of the amount of residual polymers (e.g. polyurethane from elastane of mixed textiles) according to an embodiment, a certain thermoplasticity may nevertheless be achieved in a lyocell fiber, which guides the corresponding amount of residual polymers from a starting material via the depleting process, according to an embodiment, via a lyocell method back into a lyocell molded body again.

According to an exemplary embodiment, by the pre-treatment of the used textile mixture, a subsequent depletion of foreign matters is minimized and/or the adjustment of the desired residual concentrations is facilitated. In textile recyclates already present inorganic residual constituents are e.g. metal compounds (predominantly metal oxides, in particular TiO₂, Al₂O₃, MgO, SiO₂, CeO₂, Mg(OH)₂, Al(OH)₃, ZnO). The functionalization of these oxides is suitable e.g. for a manifestation of different properties at the manufactured molded body (e.g. flame protection, antireflection, biocide, etc.).

According to an exemplary embodiment, it has further turned out, that the following substances are suitable AOs: HALS stabilizers, polyvalent phenols, in particular alkalized bi- and tri-phenols, tocopherol, oligomer lignins, and gallates. They have the advantage, that they are already approved in use as stabilizers for masking heavy metals (complexing) in NMMO-dope and their process handling in large industrial scale is unproblematic. It has now surprisingly turned out, that these AOs in NMMO, which is acting as oxidant due to its structure (N-oxide), nevertheless prevent the oxidative degradation of polymers, in particular that of elastane, which is necessary for compatibilization in the mixture.

According to an exemplary embodiment, the circumstance is considered, that certain cellulose-foreign matters may be incorporated in a certain amount in a lyocell molded body. Surprisingly, it has turned out, that certain residual materials which are not based on cellulose may be considered as desired auxiliary substances, which facilitate to incorporate other residual materials which are not based on cellulose into a lyocell molded body to a larger extent. Such a substance group, which is both non-cellulosic secondary constituent and incorporation promoter, are TPE-type plastics (e.g. elastanes). This mentioned incorporation effect operates to such an extent, that low amounts (below 2%) of polyamides (PA) and polyesters (PET below 2%) may be co-processed. In the recyclate-treatment process, this is a significant advantage, since the almost complete removal of the mentioned polymers is disproportionally elaborate and the possible acceptance of low residual amounts massively facilitates the recyclate treatment, since precisely these polymers are very frequently and commonly contained in textile recyclates. This behavior is explained by the compatibility effect of elastane between PA-PET and cellulose. The PUR-amount of elastane is responsible for this, since PUR is a polyester and a polyamide at the same time (R1.NH.CO.O.R2). The polyalkyleneoxide amount in TPEs; such as elastane, is moreover responsible, due to its typical ether structure, for the homogenization/mixture with the glycan ether compounds of the cellulose. According to embodiments of the invention, this multiple effect is also utilized in this multiple manner: i) by the process temperatures of the lyocell process, the elastane is connected in a suitable manner with the cellulose by hydrogen bonds; ii) the polyamide similarities of these TPEs enable to incorporate typical fiber polyamides (PA6 or PA6.6 or PA6.10) from used materials; iii) the ether structure leads to a high homogenization of the dope prior to the spinning process and thereby to a very good mixing (in particular also on a chemical level, since the relationship of the ether structure of the TPEs is very similar to the ether structure of the cellulose; and iv) the polyester similarities of these TPEs enable to incorporate typical fiber polyesters from used textiles. In particular, by mixing different used textile compositions, a suitable recyclate quality may be adjusted and thus the subsequent utilization may be specifically controlled.

FIG. 1 shows a flow diagram of a method for continuously providing (see reference sign 50) a treated starting material 110 according to an exemplary embodiment of the invention. At first, a cellulose-containing starting material 101 is provided 1, which is a mixture of used textiles (used clothes and/or remains from a clothing manufacture). It may be delivered from different sources (pre-/post-consumer) and may be very inhomogenous. The used textiles 101 do not only comprise cellulose, but also partially high contents of synthetic fibers (e.g. polyester). In a first stage of providing (see block 1), at first, mechanically comminuting 1 the used textiles 101 by shredding may be performed. Thereby, mainly large non-cellulosic disturbing matters may be removed from the starting material 101, for example buttons, seams, and prints of the used clothes which are at least partially used for generating the starting material 101. By mechanically comminuting, the starting material 101 may be separated into single fibers, for example.

In a further stage, the composition of the used textiles is determined (see block 2). Optionally, this stage may also be performed before comminuting. Determining the composition may be continuously performed at a (recycling) stream of used textiles. For this purpose, different automatic measurement techniques (e.g. optical and/or spectroscopic methods) may be used. Alternatively, also a skilled operator may determine the composition. Furthermore, the composition may be at least partially pre-known (e.g. in case of clothing remains from the production). The determined composition (actual value) may subsequently be compared with a target value of the predefined composition.

Corresponding to the deviation from the target value, selectively enriching (see block 4) and/or selectively depleting (see block 6) may be performed. The starting material 101 is a used textile mixture with cellulose fibers and synthetic fibers. To achieve a predefined composition, charges with known compositions (known amounts of composition components) are mixed, such that the mixture finally comprises the predefined composition. Especially suitable are the above described (cutting waste) remains from the clothing production, which comprise a substantially known composition. Moreover, used textiles with a known composition, e.g. a very high cotton content, may be added, to increase the cellulose content. Furthermore, also composition components with at least partially known composition may be removed from the starting material 101. For example; specifically sportswear may be removed, which comprises an especially high amount of polyester. Moreover, mechanically separating, e.g. a density separation, in particular by a flotation method, may be performed, to selectively deplete e.g. polyester and/or polypropylene from the cellulose. Fiber constituents may be suspended in a liquid (aqueous) medium. Separating the non-cellulosic fibers from the cellulosic fibers is successfully performed due to different physical properties in the liquid medium, in particular different gravitational, centrifugal force-related, floating, and/or electrostatic properties.

The starting material 101 with the predefined composition is then continuously supplied (see block 10) to the reaction device 150. The starting material is comminuted/shredded and may be directly supplied to the reactor 150 as solid matter or by an additional solvent. The reactor device 105 comprises a continuous boiler (digester) which operates a continuous boiling process for treating (stage 20) the starting material. The boiling process is acidic (e.g. sulfite method) or alkaline (e.g. sulfate/kraft-method or direct application of caustic soda). The starting material and the boiling solution may be supplied to the reactor device 105 initially in a separated manner, and may then be mixed. However, also previously mixing may be performed, such that the starting material 101 is supplied to the reactor device 105 in a manner at least partially solved in the boiling solution. Under application of a high temperature (e.g. 90° C. to 185° C.) and/or a high pressure (e.g. 1 to 21 bar), the treatment (see block 20) of the starting material 101 is performed. The reactor device 105 may comprise a conveyor screw, to continuously transport the starting material 101 through the boiler. During the boiling process, an at least a partial degradation of plastics (e.g. polyester saponification) takes place. In this way, plastic-depleted cellulose; but also highly pure cellulose may be provided. Downstream of the boiler, a cleaning stage may be performed. Subsequently, continuously discharging (see block 30) the treated starting material 110 follows. The treated starting material 110 is present as concentrated cellulose (in comparison with the starting material), which optionally still comprises residues of plastics.

The treated starting material 101 may undergo further (continuous) treatment stages (see block 40). These encompass e.g. a further cleaning stage and a bleaching process. The correspondingly purified cellulose-comprising starting material 110, as illustrated in block 80, is subsequently supplied to a method for manufacturing a cellulosic molded body 102. An example for such a method is a lyocell method which is described in detail with respect to the FIGS. 2 and 3 (see below). The obtained molded body 102 (e.g. as fiber in a lyocell textile or also a paper fiber) may be again recycled after use (illustrated with reference sign 90) and may be added to the cellulose-containing starting material 101 again.

FIG. 2 shows a flow diagram 80 of a method for manufacturing a regenerated cellulosic molded body 102 (compare FIG. 3) from the treated starting material 110 according to an exemplary embodiment of the invention.

The starting material 110 is provided by a continuous treatment process (see block 50, compare FIG. 1). As illustrated with block 50, a such manufactured treated starting material 110 may be used for a subsequent lyocell- or viscose method, wherein the former is described in more detail in the following.

In the following, it is described, how molded bodies 102 made of cellulose may be manufactured on basis of the cellulose-comprising starting material 110, according to an embodiment of the invention. For this purpose, the starting material 110 is supplied to a device (100, see FIG. 3) for performing a lyocell method. At first, optionally preparing (stage 62) the treated starting material 110 is performed, e.g. cleaning or comminuting. It is also possible (see block 64) to commonly utilize the cellulose-comprising starting material 110 with other cellulose-comprising materials for the subsequent lyocell method. Thus, the starting material 110 may be mixed with a further starting material, which comprises cellulose and at least one synthetic plastic, see block 64. This supplied further starting material comprises an amount of synthetic plastics, which is different from the amount of synthetic plastic in the starting material 110. Generating the regenerated cellulosic molded body may now be executed based on the starting material 110 and the further starting material, such that the regenerated cellulosic molded body 102 contains a predetermined amount of synthetic plastic. Alternatively or additionally, the further starting material may also comprise remains from a clothing manufacture, for example.

Directly after preparing 62 and/or directly after mixing 64, directly solving 68 the (pure and/or mixed) starting material 110 in a further solvent 116 (for example tertiary amine oxides, such as N-methylmorpholine-N-oxide (NMMO), for example) may be performed, advantageously without chemical pretreatment. In more detail, the mechanically comminuted (and optionally mixed) starting material 110 may be directly transferred into solution, in particular without a chemical cleaning and without an adjustment of the viscosity. In this way, the manufacturing- and/or recycling method may be performed exceptionally simple and rapid and ecological.

Alternatively, the method may comprise optionally chemically cleaning 66 the starting material 110 after preparing 62 (or after mixing 64) and prior to solving 68. Such an optional cleaning 66 may comprise at least partially removing colorants by bleaching, for example. It is thereby possible to entirely or partially discolor the starting material 110 prior to subsequently solving 68 the starting material 110 in a solvent 116, for example to manufacture white or grey molded bodies 102. Alternatively or additionally, it is also possible, that in the context of optionally chemically cleaning 66, the starting material 110 (prior or after its solving 68) is at least partially freed from cross-linkers which are cross-linking the fibers of the starting material 110. In applications, in which such cross-linkers are present between the fibers of the starting material 110, the starting material 110, for example by an alkaline or an acidic pretreatment, may be entirely or partially freed from these cross-linkers. This additionally improves the solubility of the starting material 110. By cleaning 66, at least a part of synthetic plastic may be optionally removed, if desired. For example, in this way, the amount of synthetic plastic in the molded body 102 to be manufactured may be adjusted and/or influenced.

After solving 68 the starting material 110 in the solvent (preferably NMMO), the obtained lyocell spinning solution 104 may be pressed through one or more spinning nozzles, whereby threads and/or filaments of a honey-like viscosity are generated (see block 70 which relates to spinning).

During and/or after the fall of these threads and/or filaments, they are brought in operational connection with an aqueous milieu and are thereby thinned. The concentration of the solvent 116 of the threads and/or filaments is thereby reduced in an aqueous fog and/or an aqueous liquid bath to such an extent, that the lyocell spinning solution is transferred into a solid phase made of cellulose-filaments. In other words, a precipitating, precipitation, or coagulating of the cellulose-filaments occurs, see reference sign 72. Thereby, a preform of the molded body 102 is obtained.

Furthermore, the method may comprise postprocessing 74 the precipitated lyocell-cellulose for obtaining the molded body 102 from the preform of the molded body 110. Such a posttreatment may encompass drying, impregnating and/or reshaping the obtained filaments to the final molded body 102, for example. For example, the molded body 102 may be processed by the described manufacturing method to fibers, a foil, a tissue, a fleece, a sphere, a porous sponge, or beads and may then be supplied to a further use (compare reference sign 76).

Advantageously, after the use of the molded body 102, its cellulose and optional synthetical plastics may be recovered again by performing a further method corresponding to the method stages between the reference signs 50 and 74 (see block 90). Alternatively, the cellulose and the optional further synthetical plastic of the molded body 102 may be recovered in another method, for example a viscose method.

FIG. 3 shows a device 100 for continuously providing a treated cellulose-comprising starting material 110 and for manufacturing a regenerated cellulosic molded body 102 by a lyocell method on basis of the starting material 110, according to an exemplary embodiment of the invention, which is described with reference to the FIGS. 1 and 2.

FIG. 3 shows a device 100 according to an exemplary embodiment of the invention for manufacturing a cellulose-comprising molded body 102 which may be manufactured in form of a fleece (nonwoven) as a fiber, a foil, a sphere, a textile tissue, a sponge, or in form of beads or flakes. According to FIG. 3, the molded body 102 may be manufactured directly from a spinning solution 104. The latter is converted by a coagulation fluid 106 (in particular made of air humidity) and/or a coagulation bath 191 (for example a water bath which optionally comprises tertiary amine oxides, such as N-methylmorpholine-N-oxide (NMMO)) into cellulose fibers 108 as molded body 102. By the device 100, a lyocell method may be performed. In this way, as molded body 102, for example substantially endless filaments or fibers 108 or mixtures of substantially endless filaments and fibers 108 of a discrete length may be manufactured. A plurality of nozzles which respectively have one or more openings 126 (which may also be denoted as spinning holes) are provided, to eject the lyocell spinning solution 104.

As can be taken from FIG. 3, a cellulose-based starting material 110 may be supplied to a storage reservoir 114 via a dosing unit 113 to the lyocell method 80. The starting material 110 is a treated starting material 110 which was obtained in a continuous treatment process 50 (see FIG. 1 above). For this purpose, a cellulose-comprising starting material 101, namely used textiles, are continuously supplied (see 10) with a predefined composition to a reactor device 105. In the reactor device 105, the cellulose-comprising starting material 101 is continuously treated (see 20), to obtain the treated cellulose-comprising starting material 110. Subsequently, the treated cellulose-comprising starting material 110 is continuously discharged from the reactor device 105. Furthermore, the treated cellulose-comprising starting material 110 undergoes a continuous bleaching process (see 40).

According to an embodiment, a water introduction into the cellulose-based starting material 110 may be performed by a solvent 116 which is described in more detail below (in particular NMMO). Also the cellulose-based starting material 110 itself may already contain a certain residual humidity (dry pulp frequently has a residual humidity of 5 weight percent to 8 weight percent, for example). In particular, according to the described embodiment, the starting material 110 may be directly given into a mixture of water and solvent 116 without a premoistening. An optional water container 112 which is shown in FIG. 3 may then be omitted.

According to an alternative embodiment, the cellulose-comprising starting material 110 may be additionally moistened, to thereby provide humid cellulose. For this purpose, water from an optional water container 112 may be supplied to the storage reservoir 114 via the dosing unit 113. Therefore, the dosing unit 113, controlled by a control unit 140, may supply adjustable relative amounts of water and starting material 110 to the storage reservoir 114.

A suitable solvent 116, preferably tertiary amine oxides, such as N-methylmorpholine-N-oxide (NMMO), respectively an aqueous mixture of the solvent 116, for example a 76% solution of NMMO in water, is contained in a solvent container. The concentration of the solvent 116 may be adjusted in a concentration unit 118 either by adding pure solvent or water. The solvent 116 may then be mixed with the starting material 110 with definable relative amounts in a mixing unit 119. Also the mixing unit 119 may be controlled by the control unit 140. Thereby, the cellulose-comprising starting material 110 is solved in the concentrated solvent 116 in a solving unit 120 with adjustable relative amounts, whereby the lyocell spinning solution 104 is obtained. The relative concentration ranges (also denoted as spinning window) of the components starting material 110, water, and solvent 116 in the spinning solution 104 for manufacturing cellulosic regenerate molded bodies according to the lyocell method may be adjusted in a suitable manner, as known to a skilled person.

The lyocell spinning solution 104 is supplied to a fiber generation unit 124 (which may be formed with a number of spinning bars or jets 122).

When the lyocell spinning solution 104 is guided through the openings 126 of the jets 122, it is separated into a plurality of parallel threads made of lyocell spinning solution 104. The described process control transforms the lyocell spinning solution 104 into increasingly long and thin threads, whose properties may be adjusted by a corresponding adjustment of the process conditions, controlled by the control unit 140. Optionally, a gas flow may accelerate the lyocell spinning solution 104 on its way from the openings 126 to a fiber receiving unit 132.

After the lyocell spinning solution 104 has moved through the jets 122 and further downwards, the long and thin threads of the lyocell spinning solution 104 interact with the coagulation fluid 106.

In the interaction with the coagulation fluid 106 (for example water), the solvent concentration of the lyocell spinning solution 104 is reduced, such that the cellulose of the starting material 110 coagulates and/or precipitates at least partially as long and thin cellulose fibers 108 (which may still contain residues of solvent and water).

During or after the initial formation of the individual cellulose fibers 108 made of the extruded lyocell spinning solution 104, the cellulose fibers 108 are received at the fiber receiving unit 132. The cellulose fibers 108 may immerse into the coagulation bath 191 which is illustrated in FIG. 3 (for example a water bath, optionally comprising a solvent, such as NMMO) and may complete their precipitation in the interaction with the liquid of the coagulation bath 191. Depending on the process adjustment of the coagulation, the cellulose may form cellulose fibers 108 (as shown, wherein the cellulose fibers 108 are made of one substance and/or are integrally merged with each other (“merging”), or may be present as separate cellulose fibers 108), or at the fiber receiving unit 132, a foil and/or a film made of cellulose may form (not illustrated in FIG. 3).

Thus, the cellulose fibers 108 are extruded out of the spinning nozzles of the jets 122 and are guided through the spinning bath and/or coagulation bath 191 (for example containing water and NMMO in low concentration for precipitation/coagulation), wherein the cellulose fibers 108 are guided around a respective redirecting roller 193 in the coagulation bath 191 and are supplied to a withdrawal galette (German: Abzugsgalette) 195 outside of the coagulation bath 191. The withdrawal galette 195 serves for a further transport and post-stretching of the cellulose fibers 108, to achieve a desired titer. Downstream of the withdrawal galette 195, the fiber bundle made of the cellulose fibers 108 is washed in a washing unit 180, if necessary scrooped (German: aviviert) and finally cut (not shown).

Although not illustrated in FIG. 3, a solvent 116 of the lyocell-spinning solution 104, which is removed from the cellulose fibers 108 during coagulation and a subsequent washing in the washing unit 180, may be at least partially recovered and/or recycled, and may be transferred into the storage container 114 again in a subsequent cycle.

During the transport along the fiber receiving unit 132, the molded body 102 (here in form of the cellulose fibers 108) may be washed by the washing unit 180, by the latter supplying a washing liquid for removing solvent residues. Subsequently, the molded body 102 may be dried.

Moreover, the molded body 102 may be subjected to a posttreatment, see the schematically illustrated posttreatment unit 134. For example, such a posttreatment may comprise a hydroentanglement, a needling, an impregnation, a steam treatment with a steam which is supplied under pressure, and/or a calendaring, etc.

The fiber receiving unit 132 may supply the molded body 102 to a winding unit 136, at which the molded body 102 may be wound up. The molded body 102 may then be supplied as rolling freight to an entity which manufactures products, such as wipes or textiles, on basis of the molded body 102.

FIG. 4 shows a cellulose fiber 200 in cross-section which is manufactured by a lyocell-method. The cellulose fiber 200 which is manufactured by a lyocell-method has a smooth round outer surface 202 and is homogenous and free of microscopic holes filled with cellulose material. Thus, it may be distinctly differentiated by a person skilled in the art from cellulose fibers which are manufactured by a viscose method (see reference sign 204 in FIG. 5) and from cellulose fibers made of cotton plants (see reference sign 206 in FIG. 6).

FIG. 5 shows a cellulose fiber 204 in cross-section which is manufactured by a viscose-method. The cellulose fiber 204 is cloud-shaped and comprises a plurality of arc-shaped structures 208 along its outer circumference.

FIG. 6 shows a natural cellulose fiber 206 of a cotton plant in cross-section. The cellulose fiber 206 is kidney-shaped and comprises a lumen 210 which is free of material as fully circumferentially enclosed hollow in its interior.

By means of the significant geometrical and/or structural, differences of the fibers according to FIG. 4 to FIG. 6, it is possible for a person skilled in the art, for example by a microscope, to unambiguously determine, if a cellulose fiber is formed by the lyocell-method, by the viscose-method, or is naturally formed in a cotton plant.

Supplementary, it is to be noted, that “comprising” does not exclude other elements or steps, and “a” or “an” does not exclude a plurality. Furthermore, it is noted, that features or steps, which are described with reference to one of the above embodiments, may also be used in combination with other features or steps of other embodiments described above. Reference signs in the claims shall not be construed as limitation.

1-15. (canceled)

16. A method for continuously providing a treated cellulose-comprising starting material for manufacturing a cellulosic molded body, wherein the method comprises:
supplying a cellulose-comprising starting material with a predefined composition to a reactor device;
continuously treating the cellulose-comprising starting material in the reactor device, to obtain the treated cellulose-comprising starting material; and
discharging the treated cellulose-comprising starting material from the reactor device.

17. The method according to claim 16,
wherein the cellulose-comprising starting material entirely or partially comprises remains from a clothing manufacture or used clothes.

18. The method according to claim 16, further comprising:
adjusting the predefined composition, wherein adjusting comprises:
selectively enriching at least one composition component, or
selectively depleting at least one composition component.

19. The method according to previous claim 16, wherein continuously treating further comprises:
performing a continuous boiling process using an alkaline boiling solution.

20. The method according to claim 16,
wherein the predefined composition comprises cellulosic fibers, and
wherein the predefined composition of the cellulosic fibers comprises a fluctuation range of 2.5% or less.

21. The method according to claim 16,
wherein the predefined composition comprises synthetic fibers, and
wherein the predefined composition of the synthetic fibers comprises a fluctuation range of 2.5% or less.

22. The method according to claim 16,
wherein the predefined composition comprises further synthetic fibers, and
wherein the predefined composition of the further synthetic fibers comprises a fluctuation range of 0.5% or less;
wherein the further synthetic fibers comprise at least one of the group consisting of polyamide, polyacrylic, and elastane.

23. The method according to claim 16,
wherein the predefined composition comprises 60% or more, cellulosic fibers, or
wherein the predefined composition comprises 30% or less, synthetic fibers.

24. The method according to claim 16,
wherein the predefined composition comprises at least one of the following features:
wherein the predefined composition comprises 4% or less polyamide;
wherein the predefined composition comprises 1% or less polyacrylic;
wherein the predefined composition comprises 5% or less elastane.

25. The method according to claim 16,
wherein the reactor device comprises a continuous boiler, in particular a Pandia boiler.

26. The method according to claim 16, further comprising:
performing a bleaching process after continuously discharging.

27. A method for manufacturing a regenerated, cellulosic molded body, the method comprising:
providing a treated cellulose-comprising starting material according to claim 16; and
forming the cellulosic molded body from the treated cellulose-comprising starting material.

28. The method according to claim 27,
wherein forming the cellulosic molded body from the treated starting material comprises one of the group consisting of a lyocell method, a viscose method or a paper manufacturing method.

29. The method according to claim 27,
wherein the regenerated, cellulosic molded body is selected from the group consisting of a filament, a fiber, a foil, a sponge, a microsphere, a bead, or a paper tissue.

30. Use of a continuous boiling aggregate for continuously treating a cellulose-comprising starting material being used textiles, with a predefined composition.
